(19) United States
(12) Patent Application Publication
(10) Pub. No.: US 2011/0105225 A1
(43) Pub. Date: May 5, 2011

(54) DEVICE, METHOD, AND SYSTEM FOR POSITIONING PLAYING VIDEO

(76) Inventors: Yasong Huang, Shenzhen (CN); Hongbo Liu, Shenzhen (CN); Zhaozao Li, Shenzhen (CN)

(21) Appl. No.: 12/911,414

(22) Filed: Oct. 25, 2010

(30) Foreign Application Priority Data
Oct. 31, 2009 (CN) 200910109938.6

(51) Int. Cl. A63F 13/00; A63F 13/06; A63F 9/24

(52) U.S. Cl. 463/30; 463/36; 463/42

(57) ABSTRACT

A device for positioning a playing video is provided. The device includes: a receiving engine, configured to generate a control signal according to a user instruction; and a user interface engine, configured to respond to the control signal from the receiving engine, define a display interface, present a video playing progress indicator on the display interface according to the control signal, and adjust a scale of the video playing progress indicator to determine a display range of the playing video. Meanwhile, a method and a system for positioning a playing video are provided. A video playing progress indicator is presented on a display interface according to a control signal, and a play scale of the progress indicator is adjusted to determine a display range of the playing video, so as to enhance flexibility in the detailed operation of a video progress.

### CROSS-REFERENCE TO RELATED APPLICATION

This application claims priority to Chinese Patent Application No. 200910109938.6, filed on Oct. 31, 2009, which is hereby incorporated by reference in its entirety.

### FIELD OF THE TECHNOLOGY

The present disclosure relates to the field of multimedia playing, and more particularly to a device, method, and system for positioning a playing video.

### BACKGROUND

With the continuous improvement of people's living standards, more and more importance has been attached to all-round security, and digital video recorders (DVRs) have been extensively used in daily life. The DVRs become popular in ordinary families, and particularly are widely applied in monitoring systems.

In the transition of popularity from professional DVRs to consumer DVRs, the key point lies in different operational experience. Operations of an existing device for positioning a playing video mainly include play, pause, recover, fast forward, fast reverse, and stop. In addition, the existing device for positioning a playing video indicates the progress of video playing by sliding a cursor in a progress indicator displaying the video playing progress, and specifically identifies the specific video playing progress by displaying a video progress time at a specific position of the cursor. In the detailed operation of video playing in the prior art, especially in the case that great importance should be attached to details of video progress in the monitoring field, the play control is not flexible, and the user operation is inconvenient.

### SUMMARY

The present disclosure is directed to a device, method, and system for positioning a playing video, so as to enhance flexibility in the detailed operation of a video progress.

In an embodiment, the present disclosure provides a device for positioning a playing video, which includes a receiving engine and a user interface engine. The receiving engine is configured to generate a control signal according to a user instruction. The user interface engine is configured to respond to the control signal from the receiving engine, define a display interface, present a video playing progress indicator on the display interface according to the control signal, and adjust a scale of the video playing progress indicator to determine a display range of the playing video.

In an embodiment, the present disclosure further provides a method for positioning a playing video, which includes the following steps. A control signal is generated according to a user instruction. A response is made to the control signal, a display interface is defined, a video playing progress indicator is presented on the display interface according to the control signal, and a scale of the video playing progress indicator is adjusted to determine a display range of the playing video.

In an embodiment, the present disclosure further provides a system for positioning a playing video, which includes a remote control and a device for positioning a playing video. The remote control is configured to send a user instruction. The device for positioning a playing video is configured to generate a control signal according to the user instruction, respond to the control signal, define a display interface, present a video playing progress indicator on the display interface according to the control signal, and adjust a play scale of the progress indicator to determine a display range of the playing video.

Thereby, in the embodiments of the present disclosure, a video playing progress indicator is presented on a display interface according to a control signal, and a play scale of the progress indicator is adjusted to determine a display range of the playing video, so as to enhance flexibility in the detailed operation of a video progress.

### BRIEF DESCRIPTION OF THE DRAWINGS

Apparently, the accompanying drawings in the following description are only some embodiments of the present disclosure, and persons of ordinary skill in the art can derive other drawings from the accompanying drawings without creative efforts.

FIG. 1 is a schematic view of a device for positioning a playing video in an embodiment of the present disclosure;

FIG. 2a shows a display interface defined by a user interface engine in an embodiment of the present disclosure;

FIG. 2b shows a display interface in which a display range of the playing video in FIG. 2a is contracted;

FIG. 3 shows a display interface defined by a user interface engine in another embodiment of the present disclosure;

FIG. 4 shows a display interface defined by a user interface engine in another embodiment of the present disclosure;

FIG. 5 shows a display interface defined by a user interface engine in another embodiment of the present disclosure;

FIG. 6 shows a display interface defined by a user interface engine in another embodiment of the present disclosure;

FIG. 7 shows a display interface defined by a user interface engine in another embodiment of the present disclosure;

FIG. 8 shows a display interface defined by a user interface engine in another embodiment of the present disclosure;

FIG. 9 shows implementation steps of a user interface engine in an embodiment of the present disclosure;

FIG. 10 shows an implementation scenario of a user interface engine in an embodiment of the present disclosure;

FIG. 11 shows a display interface defined by a user interface engine in another embodiment of the present disclosure;

FIG. 12 is a flow chart of a method for positioning a playing video in the present disclosure; and

FIG. 13 is a schematic view of a system for positioning a playing video in the present disclosure.

### DETAILED DESCRIPTION OF THE EMBODIMENTS

The details of the present disclosure will be clearly and completely described in the following with reference to the accompanying drawings. It is obvious that the embodiments to be described are only a part rather than all of the embodiments of the present disclosure. All other embodiments obtained by persons of ordinary skill in the art based on the embodiments of the present disclosure without creative efforts shall fall within the protection scope of the present disclosure.

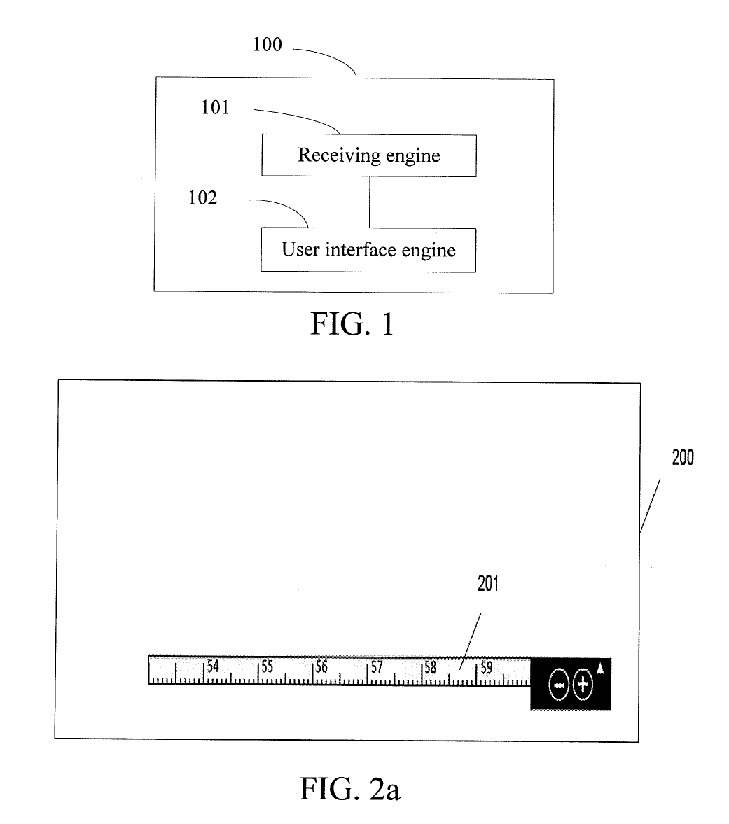

Referring to FIG. 1, a device 100 for positioning a playing video applied in the video monitoring field is provided in an embodiment of the present disclosure, which includes a receiving engine 101 and a user interface engine 102.

The receiving engine 101 is configured to generate a control signal according to a user instruction.

The user interface engine 102 is configured to respond to the control signal from the receiving engine 101, define a display interface, present a video playing progress indicator on the display interface according to the control signal, and adjust a play scale of the video playing progress indicator to determine a display range of the playing video.

It can be seen that, flexibility in the detailed operation of the video progress can be enhanced by adjusting the play scale of the video playing progress indicator to determine the display range of the playing video. In this way, the product is elegant in appearance, easy to understand, and simple to operate, and it is convenient for a monitoring user to select demanded video, thereby facilitating the interactive operation of the user.

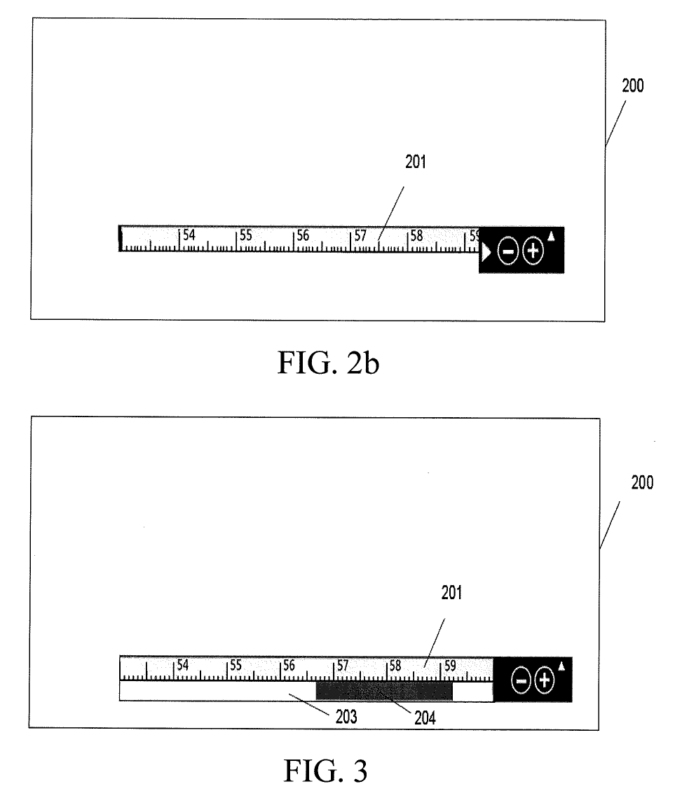

Referring to FIG. 2a, a display interface 200 defined by a user interface engine 102 is shown. In the display interface 200, a video playing progress indicator: such as a video playing display bar 201 is presented on the display interface according to a control signal, and a play scale of the video playing progress indicator 201 is adjusted to determine a display range of the playing video. The current display range of the playing video shown in the figure is a range of the play scale of 53 to 60, in which boundary values 53 and 60 are not shown in FIG. 2a, and only 54, 55, 56, 57, 58, and 59 are reserved. Herein, the play scale of the video playing progress indicator 201 may be adjusted to determine the display range of the playing video, which may be expanded to a display range from 53 to M, where M is an integer greater than 60, or contracted to a display range from 53 to N, where N is an integer smaller than 60. As shown in FIG. 2b, the display range of the playing video may be contracted to a display range from 53 to 59.3. Especially in the high-speed monitoring field, when a large number of images in 1 s are played, the 1 s time scale is expanded after the display range of the playing video is adjusted larger, so that the scale precision in 1 s can be further enhanced, and then the user interface engine 102 can obtain a more detailed video indication precision of milliseconds or microseconds, thereby meeting the requirements for determining video details in the high-speed monitoring field.

Referring to FIG. 3, optionally, the user interface engine 102 is further configured to present a play event progress indicator 203 on the display interface according to the control signal, in which the play event progress indicator 203 is matched with the video playing progress indicator 201 in time and is configured to identify event information of a determined time period of the playing video; and determine a display range of the event information through the display range of the playing video. In this way, after monitoring video information is damaged or removed, the monitoring user still can obtain some key information, for example, monitoring alarm information or hierarchical determination information of the determined time period, from the event information, so that it is convenient for the user to understand event information of an event to meet specific requirements. For example, the event information is displayed on the display interface 200 with one or more of text, sound, and image through a play scale range of the play event progress indicator 203 and an identification range of a display box 204. Particularly, when the device 100 for positioning a playing video is applied in the monitoring field, the event information herein may also include a video reason (alarm, periodic, or manual video), site description, storage address, or the like. The video is categorized into alarm video, periodic video, and manual video according to trigger modes of the video. The following implementation solutions are provided according to different requirements in specific application scenarios.

The event information of the determined time period includes one or more of the alarm information, video reason, site description, and storage address of the determined time period.

In a first solution, alarm video, periodic video, and manual video coexist, and 3 identifications are adopted to indicate video modes of the current video. For example, a represents alarm video, a=0 represents that no alarm video exists at this time, and a=1 represents that alarm video exists; b represents periodic video, b=0 represents that no periodic video exists at this time, and b=1 represents that periodic video exists; c represents manual video, c=0 represents that no manual video exists at this time, c=1 represents that manual video exists. The three identifications are also stored in the video file, so that they can be acquired at any time.

In a second solution, the three video modes do not coexist, but have priorities, that is alarm video>periodic video>manual video. If currently the video is manual video and a periodic video condition is triggered, the video changes to a periodic video, and if an alarm occurs, the video file changes to an alarm video; if currently the video is periodic video and an alarm occurs, the video file changes to an alarm video; in the case of periodic video and alarm video, the video cannot be stopped manually. An identification is adopted to indicate the video mode of the current video, for example, z=0 represents manual video, z=1 represents periodic video, and z=2 represents alarm video, and this value may be stored in the video file.

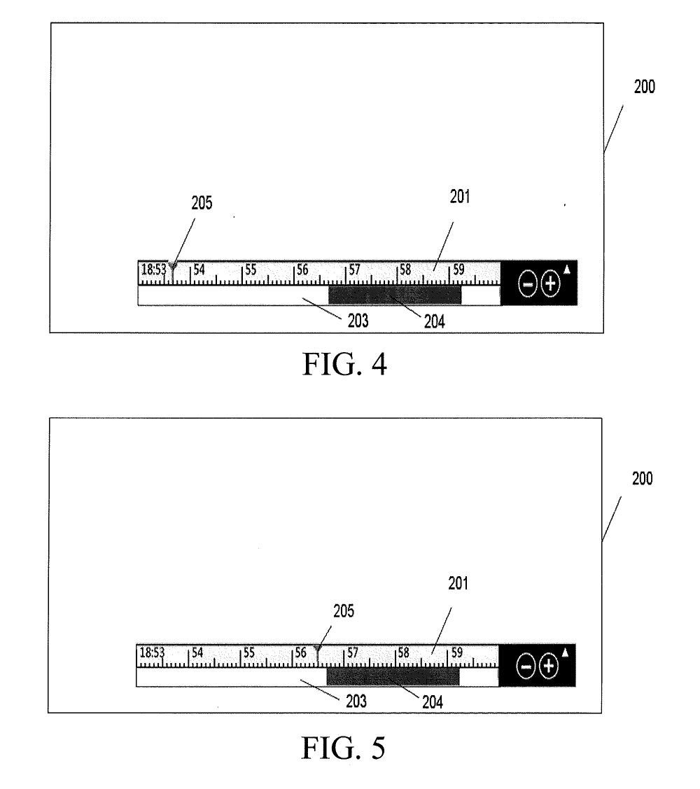

Optionally, as shown in FIG. 4, the user interface engine 102 is further configured to define an indicative cursor 205, and determine a starting point for video playing through the indicative cursor 205 on the video playing progress indicator 201. In playing, the indicative cursor 205 is configured to represent a current play position. Optionally, the current detailed play position displayed herein is time 18:53. It should be understood that, the play scale of the video playing progress indicator 201 is adjusted to determine the display range of the playing video, so as to greatly enhance the precision of a playing time of the playing video. Especially in the high-speed monitoring field, when a large number of images in 1 s are played, after the display range of the playing video is adjusted so that the scale precision in 1 s is enhanced, the indicative cursor 205 can achieve a more detailed video indication precision of milliseconds or microseconds, thereby meeting the requirements for determining video details in the high-speed monitoring field.

Referring to FIG. 5, optionally, when the scale of the video playing progress indicator 214 is adjusted to determine the display range of the playing video, the indicative cursor 205 is fixed at a midpoint of the video playing progress indicator 201, and the display range of the playing video is expanded or contracted based on the midpoint of the video playing progress indicator 201; and in playing, the cursor is not moved, while the progress indicator is wholly moved, so as to change the whole display range of the playing video. For example, the progress indicator is continuously moved from 53 to 64 to 54 to 65, 55 to 66, . . . , or 60 to 71 . . . . In this embodiment, in playing, when the video playing progress indicator 201 is wholly moved to a termination point of the video, apparently, the scale displayed on the video playing progress indicator 201 cannot be moved any more, and at this time, playing indication of the video is completed by moving the indicative cursor 205. For example, if 60 to 71 is the end point of the present video, final playing indication of the video is completed by moving the indicative cursor 205 at a midpoint of 60 to 71.

Optionally, when the scale of the video playing progress indicator 214 is adjusted to determine the display range of the playing video, the indicative cursor 205 may also be fixed at a certain point on the video playing progress indicator 201, and the display range of the playing video is expanded or contracted based on the certain point of the video playing progress indicator 201; and in playing, the cursor is not moved, while the progress indicator is wholly moved, so as to change the whole display range of the playing video.

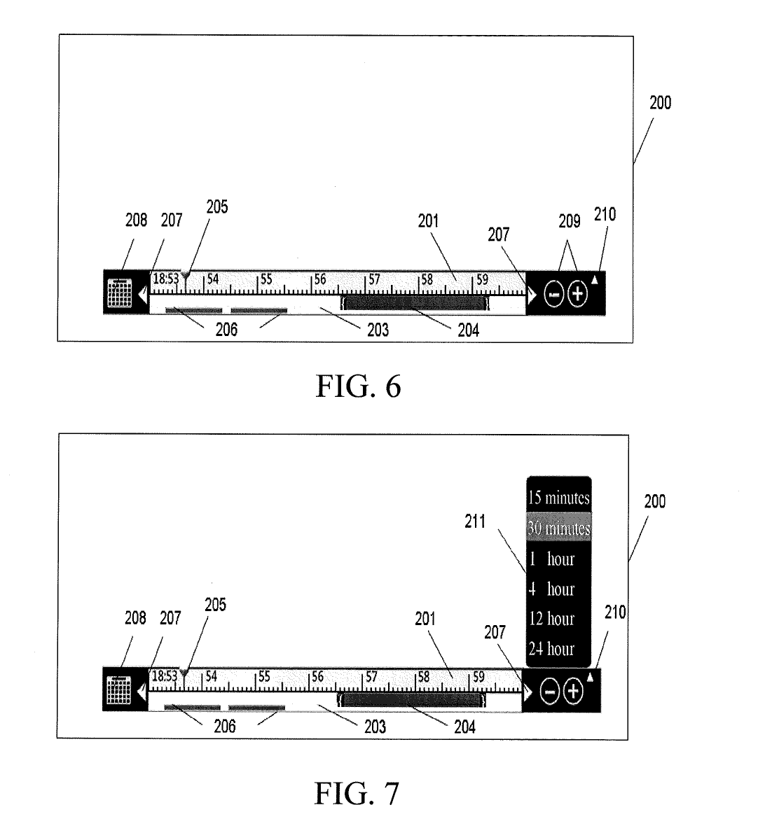

Referring to FIG. 6, optionally, the adjustment of the scale of the video playing progress indicator 201 to determine the display range of the playing video may include: continuously expanding the display range of the playing video to 53 to M, where M is an integer greater than 60, or contracting the display range of the playing video to 53 to N, where N is an integer smaller than 60, by adjusting an up/down button 209 according to a preset time period based on the current scale of the video playing progress indicator 201 displayed as 53 to 60. Here, the preset time period is M to 52. Or, the display range of the playing video may be wholly moved by dragging an arrow 207, for example, the whole scale range is changed from the current play scale in the range of 53 to 60 to 54 to 61, 55.2 to 62.2, or 61 to 68. Or, the play range may be changed to 52 to 61, 51 to 61, or 40 to 73 based on the midpoint of the current play scale of 53 to 60, so as to be proportionally scaled down or up. Definitely, the adjustment of the scale of the video playing progress indicator 201 to determine the display range of the playing video may also include: directly determining the display range of the playing video according to preset time periods in a drop-down button 210. Before adjusting the scale of the video playing progress indicator to determine the display range of the playing video, the method further includes: determining a date of the playing video through a date field 208 when playing. In this embodiment, for example, event information is displayed on the display interface 200 as a color image through a play scale range on the play event progress indicator 203 and an identification range of the display box 204. For example, the specific event information is reflected through a color on a color event indicator 206 on the play event progress indicator 203. For example, red color of the color event indicator 206 denotes an alarm, and yellow color of the color event indicator 206 denotes a specific site description.

Referring to FIG. 7, the direct determination of the display range of the playing video according to the preset time periods in the drop-down button 210 is specifically as follows: obtaining a drop-down button box 211 on the display interface 200 by selecting the drop-down button 210, and then directly determining a preset time period, for example, 15 minutes, 30 minutes, 1 hour, 24 hours, and so on.

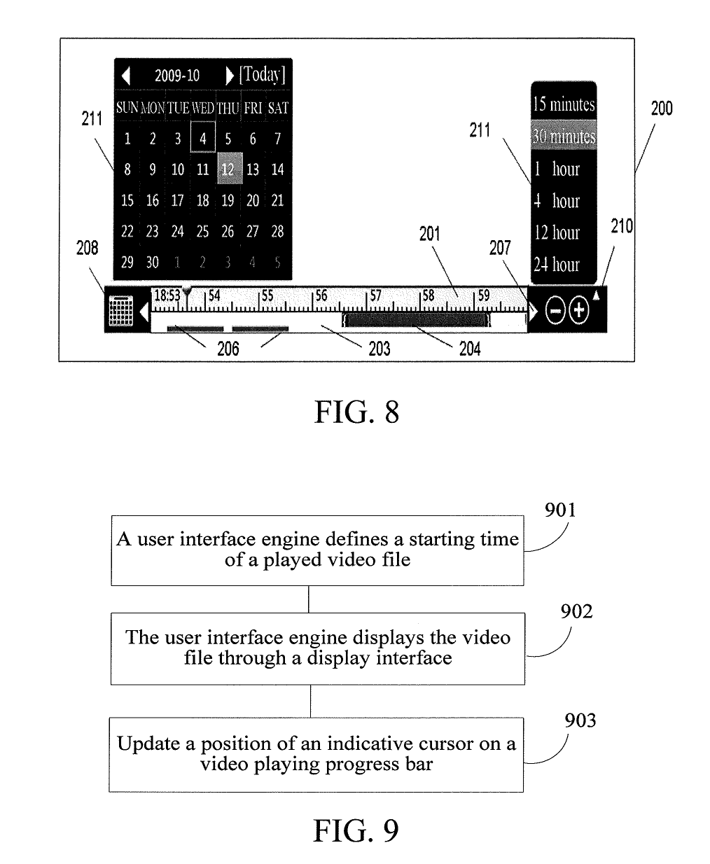

Referring to FIG. 8, the determination of the date of the playing video through the date field 208 is specifically as follows: directly determining a desired date of playing the video, for example, Oct. 12, 2009, by selecting through a date interface button 211.

Referring to FIG. 9, specific implementation steps of a user interface engine in a device for positioning a playing video is disclosed in this embodiment. The user interface engine 201 is configured to perform the following steps.

In Step 901, the user interface engine defines a starting time of a playing video file.

In Step 902, the user interface engine displays the video file through a display interface. Specifically, the user interface engine finds corresponding information in a video index file according to a scale of a video playing progress indicator, determines a storage position of the playing video according to the corresponding information in the video index file, reads video data, optionally, decodes and displays the video file, and outputs to display the read video file through the display interface after matching a time length of the read video file with a precision of the video playing progress indicator.

In Step 903, finally and optionally, a position of an indicative cursor on the video playing progress indicator is updated. In the case that the indicative cursor is not moved and the progress indicator is moved, a position of the progress indicator is updated.

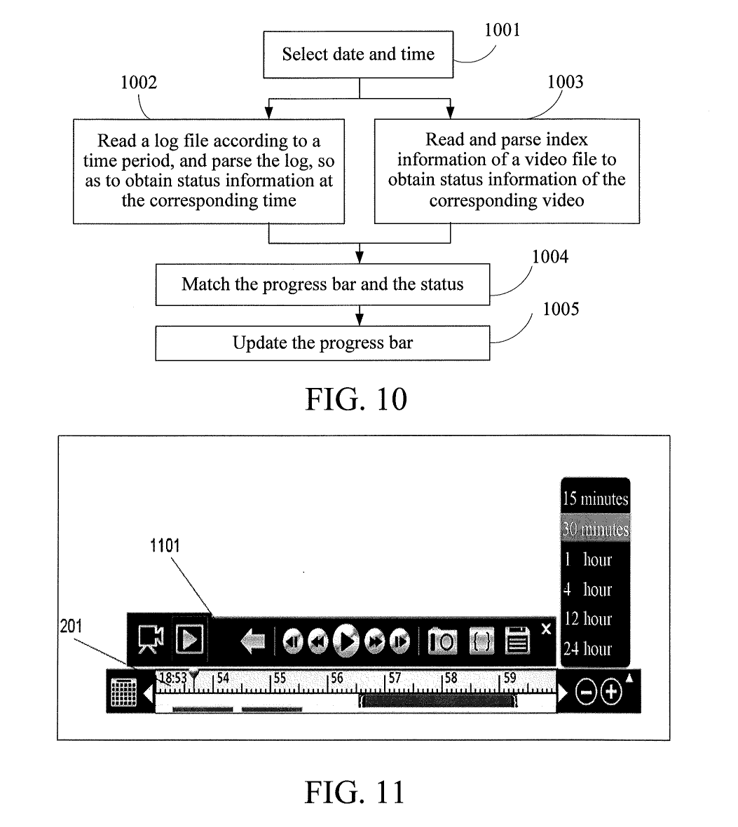

Referring to FIG. 10, another specific implementation scenario of the user interface engine in the device for positioning a playing video is disclosed in this embodiment. The user interface engine is configured to perform the following steps.

In Step 1001, date and time are selected on the interface.

In Step 1002, a log file is read according to a time period, and the log is parsed to obtain status information at the corresponding time. Specifically, the system reads a log file according to the date and time to find the log in a certain time period, and then parses the log file according to a predetermined log storage rule, so as to obtain status information at the corresponding time. The status information includes: a video reason (alarm, periodic, or manual video), a site description, a storage address, and so on.

In Step 1003, index information of a video file is read and parsed to obtain status information of corresponding video data. Specifically, the system reads the video file according to the date and time to find corresponding video index information in the time period, and parses the index information, so as to obtain status information of the corresponding video data. The status information includes: a storage position of video data, a time length of video data, an audio/video format, and so on.

In Step 1004, the status information obtained in Step 1002 and/or Step 1003 is matched with the progress indicator, so that the status information is one-to-one corresponding to the entire time axis. A scale precision of display is calculated according to the time length to be displayed required by the video playing progress indicator on the display interface.

In Step 1005, the updated progress indicator is displayed.

It should be understood that, in the above technical solution, Steps 1002 and 1003 are optional and may exist independently. If the video file index contains enough information, the branch of the log file in Step 1002 may be omitted.

Referring to FIG. 11, the display interface 200 defined by the user interface engine 102 may be displayed in combination with other display modes. In FIG. 11, the video playing progress indicator 201 may display operation sets including play, fast forward, fast reverse, and pause in combination with ordinary operating buttons 1101.

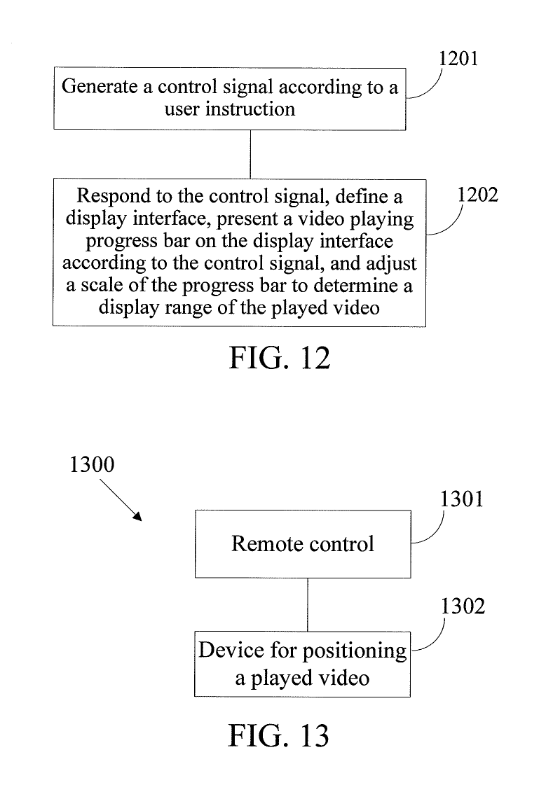

Referring to FIG. 12, a method for positioning a playing video is provided in an embodiment of the present disclosure, which includes the following steps.

In Step 1201, a control signal is generated according to a user instruction.

In Step 1202, a response is made to the control signal, a display interface is defined, a video playing progress indicator is presented on the display interface according to the control signal, and a scale of the video playing progress indicator is adjusted to determine a display range of the playing video.

Thereby, the play scale of the video playing progress indicator is adjusted to determine the display range of the playing video, which enhances flexibility in the detailed operation of a video progress, so that it is convenient for a monitoring user to select a demanded video, thereby facilitating the interactive operation of the user.

Optionally, in FIG. 12 in the embodiment of the present disclosure, the method further includes the following step.

A play event progress indicator is presented on the display interface according to the control signal, in which the play event progress indicator is matched with the video playing progress indicator in time and is configured to identify event information of a determined time period of the playing video; and a display range of the event information is determined through the display range of the playing video, thereby further facilitating user operation. Particularly, when the method is applied in the monitoring field, the event information herein may also include a video reason (alarm, periodic, or manual video), a site description, a storage address, or the like. The video is categorized into alarm video, periodic video, and manual video according to trigger modes of the video.

Optionally, in FIG. 12 in the embodiment of the present disclosure, the method further includes: defining an indicative cursor, and determining a starting point for video playing through the indicative cursor on the video playing progress indicator, in which in playing, the cursor is configured to represent a current play position, thereby further facilitating the user operation.

Optionally, in FIG. 12 in the embodiment of the present disclosure, when the scale of the video playing progress indicator is adjusted to determine the display range of the playing video, the indicative cursor is fixed at a midpoint of the video playing progress indicator, and the display range of the playing video is expanded or contracted based on the midpoint of the video playing progress indicator; and in playing, the cursor is not moved, while the progress indicator is wholly moved, thereby further facilitating the user operation.

Optionally, in FIG. 12 in the embodiment of the present disclosure, the adjustment of the scale of the video playing progress indicator to determine the display range of the playing video includes: continuously adjusting the display range of the playing video according to preset time periods, or directly determining the display range of the playing video according to a preset time period, thereby further facilitating the user operation.

Referring to FIG. 13, a system 1300 for positioning a playing video is further provided in an embodiment of the present disclosure, which includes a remote control 1301 and a device 1302 for positioning a playing video.

The remote control 1301 is configured to send a user instruction.

The device 1302 for positioning a playing video is configured to generate a control signal according to the user instruction, respond to the control signal, define a display interface, present a video playing progress indicator on the display interface according to the control signal, and adjust a play scale of the progress indicator to determine a display range of the playing video.

Thereby, flexibility in the detailed operation of the video progress can be enhanced by adjusting the play scale of the video playing progress indicator to determine the display range of the playing video, so that the system is simple to operate, and it is convenient for a monitoring user to select the demanded video, thereby facilitating the interactive operation of the user.

Optionally, the device 1302 for positioning a playing video in this embodiment may be replaced by the device 100 for positioning a playing video in FIG. 1, and the device 1302 for positioning a playing video is further configured to present a play event progress indicator on the display interface according to the control signal, in which the play event progress indicator is matched with the video playing progress indicator in time and is configured to identify event information of a determined time period of the playing video; and determine a display range of the event information through the display range of the playing video. Particularly, when the device 100 for positioning a playing video is applied in the monitoring field, the event information herein may also include a video reason (alarm, periodic, or manual video), a site description, a storage address, or the like. The video is divided into alarm video, periodic video, and manual video according to trigger modes of the video.

Optionally, the device for positioning a playing video is further configured to define an indicative cursor, and determine a starting point for video playing through the indicative cursor on the video playing progress indicator. In playing, the cursor is configured to represent a current play position.

When the scale of the video playing progress indicator is adjusted to determine the display range of the playing video, the indicative cursor is fixed at a midpoint of the video playing progress indicator, and the display range of the playing video is expanded or contracted based on the midpoint of the video playing progress indicator; and in playing, the cursor is not moved, while the progress indicator is wholly moved.

To sum up, the embodiments of the present disclosure provide the device, method, and system for positioning a playing video, which can enhance flexibility in the detailed operation of a video progress by adjusting a play scale of a video playing progress indicator to determine a display range of the playing video, so that the product is elegant in appearance, easy to understand, and simple to operate, and it is convenient for a monitoring user to select the demanded video, thereby facilitating the interactive operation of the user.

Persons of ordinary skill in the art should understand that all or a part of the processes of the method according to the embodiments may be implemented by a computer program instructing relevant hardware. The program may be stored in a computer readable storage medium. When the program is run, the processes of the method according to the embodiments are performed. The storage medium may be a magnetic disk, an optical disk, a Read-Only Memory (ROM), or a Random Access Memory (RAM).

The above descriptions are merely specific embodiments of the present disclosure, but are not intended to limit the protection scope of the present disclosure. Various variations or replacements easily thought of by persons skilled in the art without departing from the technical scope of the present disclosure should fall within the protection scope of the present disclosure as defined by the claims.

What is claimed is:

1. A device for positioning a playing video, comprising:
a receiving engine configured to generate a control signal according to a user instruction; and
a user interface engine configured to respond to the control signal from the receiving engine, define a display interface, present a video playing progress indicator on the display interface according to the control signal, and adjust a scale of the video playing progress indicator to determine a display range of the playing video.

2. The device according to claim 1, wherein the user interface engine is further configured to present a play event progress indicator on the display interface according to the control signal, wherein the play event progress indicator is matched with the video playing progress indicator in time and is configured to identify event information of a determined time period of the playing video; and determine a display range of the event information through the display range of the playing video.

3. The device according to claim 2, wherein the device is applied in a monitoring field, and wherein the event information of the determined time period comprises at least one of the following:
alarm information, a video reason, a site description, and a storage address of the determined time period.

4. The device according to claim 1,
wherein the user interface engine is further configured to define an indicative cursor, and determine a starting point for video playing through the indicative cursor on the video playing progress indicator, and
wherein the cursor is configured to represent a current play position in playing video.

5. The device according to claim 4,
wherein, when adjusting the scale of the video playing progress indicator to determine the display range of the playing video, the indicative cursor is fixed at a midpoint of the video playing progress indicator,
wherein the display range of the playing video is expanded or contracted based on the midpoint of the video playing progress indicator, and
wherein the cursor is not moved in playing while the progress indicator is wholly moved.

6. The device according to claim 1, wherein adjusting the scale of the video playing progress indicator to determine the display range of the playing video comprises at least one of the following:
continuously adjusting the display range of the playing video according to preset time periods,
directly determining the display range of the playing video according to a preset time period, and
wholly moving the display range of the playing video by dragging an arrow.

7. The device according to claim 1, wherein before adjusting the scale of the video playing progress indicator to determine the display range of the playing video, further comprises: determining a date of the playing video when playing.

8. The device according to claim 1, wherein after adjusting the scale of the video playing progress indicator to determine the display range of the playing video, the user interface engine is further configured to:
find a video index file according to the scale of the video playing progress indicator,
determine a storage position of the playing video according to the video index file,
read the playing video file, and
output to display the read playing video file through the display interface after matching time length of the read playing video file with a precision of the video playing progress indicator.

9. A computer implemented method for positioning a playing video, comprising:
generating, by a control device, a control signal according to a user instruction;
responding, by a user interface engine, to the control signal,
defining, by the user interface engine, a display interface,
presenting, by the user interface engine, a video playing progress indicator on the display interface according to the control signal, and
adjusting, by the user interface engine, a scale of the video playing progress indicator to determine a display range of the playing video.

10. The method according to claim 9, further comprising:
presenting a play event progress indicator on the display interface according to the control signal, wherein the play event progress indicator is matched with the video playing progress indicator in time and is configured to identify event information of a determined time period of the playing video; and
determining a display range of the event information through the display range of the playing video.

11. The method according to claim 9, further comprising:
defining an indicative cursor, and
determining a starting point for video playing through the indicative cursor on the video playing progress indicator,
wherein in playing, the cursor is configured to represent a current play position.

12. The method according to claim 11,
wherein in the adjusting the scale of the video playing progress indicator to determine the display range of the playing video, the indicative cursor is fixed at a midpoint of the video playing progress indicator, and the display range of the playing video is expanded or contracted based on the midpoint of the video playing progress indicator; and
wherein the cursor is not moved in playing while the progress indicator is wholly moved.

13. The method according to claim 9, wherein adjusting the scale of the video playing progress indicator to determine the display range of the playing video comprises at least one of the following:
continuously adjusting the display range of the playing video according to preset time periods, and
directly determining the display range of the playing video according to a preset time period.

14. A system for positioning a playing video, comprising:
a remote control configured to send a user instruction; and
a device for positioning a playing video, wherein the device is configured to generate a control signal according to the user instruction, respond to the control signal, define a display interface, present a video playing progress indicator on the display interface according to the control signal, and adjust a play scale of the progress indicator to determine a display range of the playing video.

15. The system according to claim 14,
wherein the device for positioning a playing video is further configured to present a play event progress indicator on the display interface according to the control signal,
wherein the play event progress indicator is matched with the video playing progress indicator in time and is configured to identify event information of a determined time period of the playing video; and
wherein the display range of the playing video determines a display range of the event information.

16. The system according to claim 14, wherein the device for positioning a playing video is further configured to define an indicative cursor, and determine a starting point for video playing through the indicative cursor on the video playing progress indicator, and the cursor is configured to represent a current play position in playing video.

17. The system according to claim 14,
wherein in adjusting the scale of the video playing progress indicator to determine the display range of the playing video, the indicative cursor is fixed at a midpoint of the video playing progress indicator, and the display range of the playing video is expanded or contracted based on the midpoint of the video playing progress indicator; and
wherein the cursor is not moved in playing while the progress indicator is wholly moved.
